(19) United States
(12) Patent Application Publication
(10) Pub. No.: US 2024/0066513 A1
(43) Pub. Date: Feb. 29, 2024

(54) POROUS CATALYST CARRIER FILAMENTS AND METHODS OF FORMING THEREOF

(71) Applicant: SAINT-GOBAIN CERAMICS & PLASTICS, INC., Worcester, MA (US)

(72) Inventors: James August MCCARTHY, Streetsboro, OH (US); Jingyu SHI, Hudson, OH (US); Stephen DAHAR, Solon, OH (US); Patrick NGUYEN VAN NUOI, Cavaillon (FR)

(21) Appl. No.: 18/258,589

(22) PCT Filed: Dec. 17, 2021
(86) PCT No.: PCT/US2021/073017

§ 371 Date: Jun. 21, 2023

Related U.S. Application Data
(60) Provisional application No. 63/128,314, filed on Dec. 21, 2020.

(51) Int. Cl. B01J 35/06; B01J 35/00; B01J 35/02; B01J 35/10

(52) U.S. Cl. CPC B01J 35/06; B01J 35/0026; B01J 35/026; B01J 35/1004; B01J 35/1033

(57) ABSTRACT

A method of forming a batch of porous catalytic carrier filaments may include providing a precursor mixture, forcing the precursor mixture at a fixed rate through an orifice and then through a multiplicity of perforations in a belt, where the belt moves across and in tight registry with said orifice to form a batch of precursor catalytic carrier filaments, drying the batch of precursor porous catalytic carrier filaments to form the batch of porous catalytic carrier filaments, and firing (i.e. calcining) the batch of greenware porous catalytic carrier filaments to form the batch of porous catalytic carrier filaments. The batch of porous catalytic carrier filaments may have an average pore volume of at least about 0.1 cm³/g.

### TECHNICAL FIELD

The following is directed generally to porous catalyst carrier filaments, and methods of making the same.

### BACKGROUND ART

Catalyst carriers may be used in a wide variety of applications and, in particular, the structural design of catalyst carriers is directly connected to their performance during a catalytic process. Generally, a catalyst carrier needs to possess, in combination, at least a minimum surface area on which a catalytic component may be deposited, known as a geometric surface area (GSA), high water absorption, and crush strength. In addition, catalytic processes may include packing multiple catalyst carriers in a reactor tube where the general structure of the carriers affects the packing ability of the filaments and thus the flow of fluid through the reactor tube. In such reactor tubes, geometric size, and shape of the carrier, including GSA, must be balanced with the resistance to fluid flow caused by the packing of the catalytic filaments, a performance parameter known as pressure drop, and other parameters, such as piece count. In addition, continuity in the shape of catalytic carrier filaments can improve their overall performance. Maintaining the necessary balance between GSA and desired performance parameters of a catalyst carrier is achieved by extensive experimentation making the catalyst carrier art even more unpredictable than other chemical process art. Accordingly, the industry continues to demand improved catalyst carrier designs, and the ability to produce such filaments in mass with consistent shape and size, in order to maximize desired carrier performance.

### SUMMARY OF THE INVENTION

According to a first aspect, a method of forming a batch of porous catalytic carrier filaments may include providing a precursor mixture, forcing the precursor mixture at a fixed rate through an orifice, and then through a multiplicity of perforations in a belt, where the belt moves across and in tight registry with said orifice to form a batch of precursor catalytic carrier filaments, drying the batch of precursor porous catalytic carrier filaments to form the batch of greenware porous catalytic carrier filaments, and firing (i.e., calcining) the batch of greenware porous catalytic carrier filaments to form the batch of porous catalytic carrier filaments. The batch of porous catalytic carrier filaments may have an average pore volume of at least about 0.1 cm³/g.

According to another aspect, a method of forming a batch of porous catalytic carrier filaments may include providing a precursor mixture, forcing the precursor mixture at a fixed rate through an orifice and then through a multiplicity of perforations in a belt, where the belt moves across and in tight registry with said orifice to form a batch of precursor catalytic carrier filaments, drying the batch of precursor porous catalytic carrier filaments to form the batch of greenware porous catalytic carrier filaments, and firing (i.e., calcining) the batch of greenware porous catalytic carrier filaments to form the batch of porous catalytic carrier filaments. The batch of porous catalytic carrier filaments may have an average specific surface area of at least about 0.1 m²/g.

According to still another aspect, a method of forming a batch of porous catalytic carrier filaments may include providing a precursor mixture, forcing the precursor mixture at a fixed rate through an orifice, and then through a multiplicity of perforations in a belt, where the belt moves across and in tight registry with said orifice to form a batch of precursor catalytic carrier filaments, drying the batch of precursor porous catalytic carrier filaments to form the batch of porous greenware catalytic carrier filaments, and firing (i.e., calcining) the batch of greenware porous catalytic carrier filaments to form the batch of porous catalytic carrier filaments. The batch of porous catalytic carrier filaments may have an average packing density of not greater than about 1.9 g/cm³.

According to yet another aspect, a batch of porous catalytic carrier filaments may have an average aspect ratio (L/D) of at least about 0.5. The batch of porous catalytic carrier filaments may further have an average pore volume of at least about 0.1 cm³/g.

According to still another aspect, a batch of porous catalytic carrier filaments may have an average aspect ratio (L/D) of at least about 0.5. The batch of porous catalytic carrier filaments may further have an average specific surface area of at least about 0.1 m²/g.

According to another aspect, a batch of porous catalytic carrier filaments may have an average aspect ratio (L/D) of at least about 0.5. The batch of porous catalytic carrier filaments may further have an average packing density of not greater than about 1.9 g/cm³.

According to yet another aspect, a system for forming a batch of porous catalytic carrier filaments may include an application zone that may include a shaping assembly. The shaping assembly may include a reservoir configured to force a precursor mixture at a fixed rate through an orifice and then through a multiplicity of perforations in a belt. The belt may move across and in tight registry with said orifice to form a batch of precursor porous catalytic carrier filaments. The system may further include a drying zone that may include a first heat source and it may be configured to dry the batch of precursor porous catalytic carrier filaments to form the batch of porous greenware catalytic carrier filaments. The system may further include a firing (i.e., calcining) zone that may include a second heat source and may be configured to form the batch of greenware porous catalytic carrier filaments into the batch of porous catalytic carrier filaments. The batch of porous catalytic carrier filaments may further have an average pore volume of at least about 0.1 cm³/g.

According to still another aspect, a system for forming a batch of porous catalytic carrier filaments may include an application zone that may include a shaping assembly. The shaping assembly may include a reservoir configured to force a precursor mixture at a fixed rate through an orifice and then through a multiplicity of perforations in a belt. The belt may move across and in tight registry with said orifice to form a batch of precursor porous greenware catalytic carrier filaments. The system may further include a firing (i.e., calcining) zone that may include a second heat source and may be configured to form the batch of greenware porous catalytic carrier filaments into the batch of porous catalytic carrier filaments. The batch of porous catalytic carrier filaments may further have an average specific surface area of at least about 0.1 m²/g.

According to yet another aspect, a system for forming a batch of porous catalytic carrier filaments may include an application zone that may include a shaping assembly. The shaping assembly may include a reservoir configured to force a precursor mixture at a fixed rate through an orifice and then through a multiplicity of perforations in a belt. The belt may move across and in tight registry with said orifice to form a batch of precursor porous catalytic carrier filaments. The system may further include a drying zone that may include a first heat source and it may be configured to dry the batch of precursor porous catalytic carrier filaments to form the batch of porous greenware catalytic carrier filaments. The system may further include a firing (i.e., calcining) zone that may include a second heat source and may be configured to form the batch of greenware porous catalytic carrier filaments into the batch of porous catalytic carrier filaments. The batch of porous catalytic carrier filaments may further have an average packing density of not greater than about 1.9 g/cm³.

### BRIEF DESCRIPTION OF THE DRAWINGS

The present disclosure can be better understood, and its numerous features and advantages made apparent to those skilled in the art by referencing the accompanying drawings.

FIG. 1 is an illustration of a flowchart of a method of making a batch of porous catalytic carrier filaments in accordance with an embodiment.

FIG. 2 includes a schematic of a system for forming a batch of porous catalytic carrier filaments in accordance with an embodiment.

FIG. 3 includes an illustration of a porous catalytic carrier filament formed according to embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

The use of the same reference symbols in different drawings indicates similar or identical items.

### DETAILED DESCRIPTION OF THE PREFERRED EMBODIMENT(S)

The following description, in combination with the figures, is provided to assist in understanding the teachings disclosed herein. The following discussion will focus on specific implementations and embodiments of the teachings. This discussion is provided to assist in describing the teachings and should not be interpreted as a limitation on the scope or applicability of the teachings.

The term “averaged,” when referring to a value, is intended to mean an average, a geometric mean, or a median value. As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25. Moreover, it will be appreciated that references to values stated as “at least about,” “greater than,” “less than,” or “not greater than” can include a range of any minimum or maximum value noted therein.

Embodiments described herein are generally directed to the formation of a batch of porous catalytic carrier filaments having generally uniform shape (i.e., aspect ratio) throughout the batch.

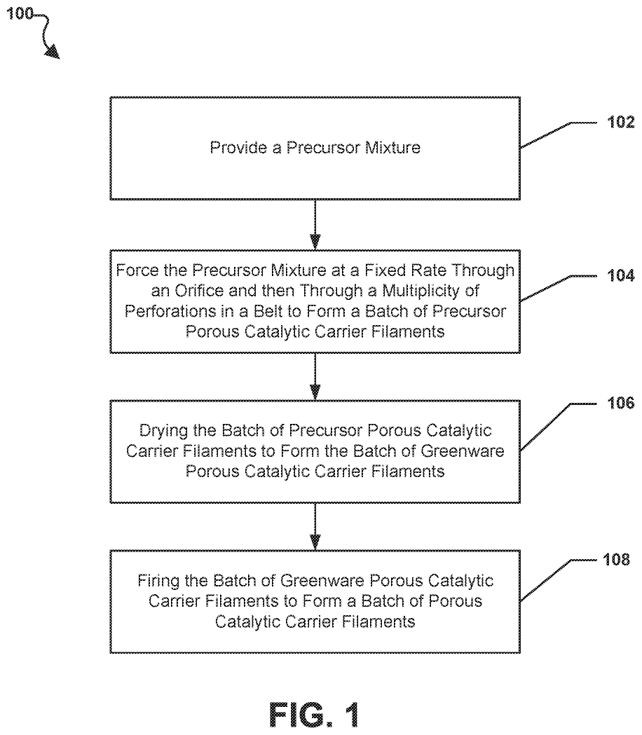

Referring initially to a method of forming a batch of shaped catalytic carrier filaments, FIG. 1 illustrates a porous catalytic carrier filament forming process generally designated 100. Porous catalytic carrier filaments forming process 100 may include a first step 102 of providing a precursor mixture, a second step 104 of forcing the precursor mixture at a fixed rate through an orifice and then through a multiplicity of perforations in a belt, where the belt moves across and in tight registry with said orifice to form a batch of precursor porous catalytic carrier filaments, a third step 106 of drying the batch of precursor porous catalytic carrier filaments to form the batch of greenware porous catalytic carrier filaments, and a fourth step 108 of firing (i.e., calcining) the batch of greenware porous catalytic carrier filaments to form the batch of porous catalytic carrier filaments.

According to still other embodiments, it will be appreciated that the porous catalytic carrier filaments forming process 100 may include additional, optional, steps, such as, additional drying steps, which may occur at different times during the forming process 100. For example, the porous catalytic carrier filaments forming process 100 may include an additional drying step between the third step 106 of drying the batch of precursor porous catalytic carrier filaments to form the batch of greenware porous catalytic carrier filaments, and the fourth step 108 of firing (i.e., calcining) the batch of greenware porous catalytic carrier filaments to form the batch of porous catalytic carrier filaments.

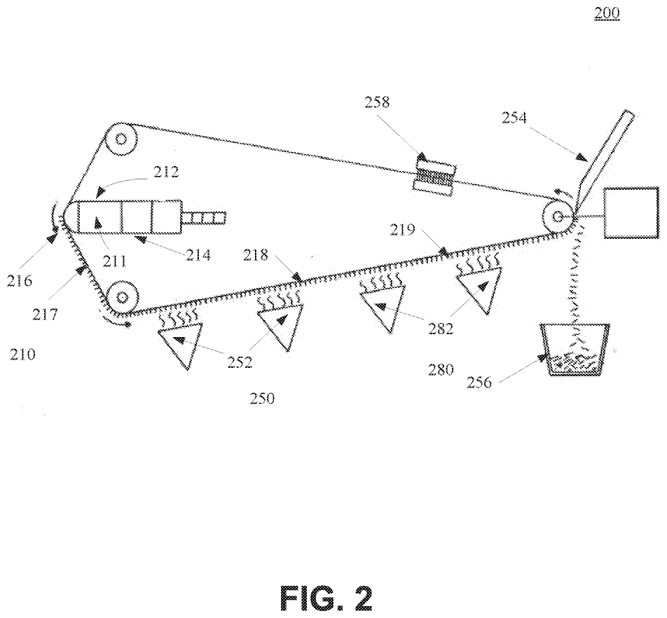

FIG. 2 includes an illustration of a system that may be used in forming a batch of porous catalytic carrier filaments in accordance with embodiments described herein. As illustrated, a system 200 may include an application zone 210, a drying zone 250, and a firing zone 280. As shown in FIG. 2, the application zone 210 may include a reservoir 212 for holding a precursor mixture 211, a force means 214 (e.g., a piston extruder) configured to force the precursor mixture 211 through a continuous, perforated belt loop 216 while the belt loop 216 is in motion. According to particular embodiments, as the belt loop 216 moves past the forcing means 214, the precursor mixture emerges from the side of the belt loop 216, opposite of the force means 214, as a batch of precursor catalytic carrier filaments 217, which are inherently so sticky that they would adhere to each other if permitted to make contact. The batch of precursor catalytic carrier filaments 217 adhere to the belt loop 216 as it moves away from the forcing means 214, out of the application zone 210 and into the drying zone 250. According to a certain embodiment, the precursor catalytic carrier filaments 217 are treated within the drying zone to make them non-sticky, preferably dried or de-watered by a drying means 252, such as hot air blowers, positioned in the drying zone 250 downstream of the forcing means 214, which transforms the batch of precursor catalytic carrier filaments 217 into a batch of greenware porous catalytic carrier filaments 218. As used herein, “downstream” means a position in the direction of the forward motion of the belt loop 216. According to still other embodiments, the greenware porous catalytic carrier filaments 218 move away from the drying zone 250 and into the firing zone 280. According to other embodiments, the greenware porous catalytic carrier filaments 218 are fired within the firing zone 280 by a firing means 282, such as a heater, to transform the greenware porous catalytic carrier filaments 219.

It will be appreciated that alternative embodiments may include production of the final batch of porous catalytic carrier filaments being formed from the greenware porous catalytic carrier filaments without firing. Accordingly, for purpose of such embodiments, the batch of greenware porous catalytic carrier filaments 218 may become the batch of porous catalytic carrier filaments 219 as soon as they are translated away from the drying zone. Further, it will be appreciated that alternative embodiments may include production of the final batch or porous catalytic carrier filaments through a firing step that occurs at a later time than the original production. Accordingly, for purposes of such embodiments, the batch of greenware porous catalytic carrier filaments 218 may be translated away from the drying zone, separated from the belt, and stored for firing at a separate time. Further, for purposes of such embodiments, the system for producing of such embodiments may not include an attached firing zone or the firing zone may be an entirely separate component from the system for producing the filaments.

According to certain embodiments, keeping the precursor catalytic carrier filaments 217 apart until they are no longer adherent to each other permits use of lower percent solids dispersions. This in turn facilitates the use of smaller openings in the belt loop, resulting in the production of very fine grit sizes without the need for classification. Also, the lower solids enable the use of lower pressures when employing an extruder as the forcing means 214.

According to certain embodiments, the drying means 252 is preferably a drying means which may be any suitable means such as a drying chamber, hot air blowers, radiant heaters, microwaves, dry air or gas, or a water-extracting solvent.

In accordance with an embodiment, the drying means 252 can act at a particular temperature. For example, the drying means 252 can act at a temperature of not greater than about 300° C. In other embodiments, the drying means 252 can act at a temperature of not greater than about 250° C., not greater than about 200° C., not greater than about 180° C., not greater than about 160° C., not greater than about 140° C., not greater than about 120° C., not greater than about 100° C., not greater than about 90° C., not greater than about 80° C., or even not greater than about 70° C. Some suitable temperatures for drying can be at least about 10° C., such as at least about 15° C., at least about 20° C., at least about 25° C., at least about 30° C., at least about 35° C., or even at least about 40° C. It will be appreciated that in certain non-limiting embodiments, the drying means 252 can act at a temperature within a range between any of the temperatures noted above.

Alternatively, the drying means 252 can be a coating means which coats the surfaces of the filamentary filaments with a very fine dust. Suitable such dusts for alumina filamentary filaments include alpha alumina or boehmite, since these materials will not be deleterious to the eventual use of the filaments.

In accordance with another embodiment, the firing means 282 can act at a particular temperature. For example, the firing means 282 can act at a temperature of not greater than about 2000° C. In other embodiments, the firing means 282 can act at a temperature of not greater than about 1950° C., not greater than about 1900° C., not greater than about 1850° C., not greater than about 1800° C., not greater than about 1750° C., not greater than about 1500° C., not greater than about 1250° C., or even not greater than about 1000° C. Some suitable temperatures for firing can further be at least about 200° C., such as at least about 250° C., at least about 300° C., at least about 350° C., at least about 400° C., at least about 450° C., or even at least about 500° C. It will be appreciated that in certain non-limiting embodiments, the firing means 282 can act at a temperature within a range between any of the temperatures noted above.

According to still other embodiments and as shown in FIG. 2, after the belt loop 216 with the batch of porous catalytic carrier filaments 219 thereon passes by or through the firing means 282, the batch of porous catalytic carrier filaments 219 are removed from the belt loop by a removing means 254 located downstream of the firing means 282. Suitable removing means 254 include, for example, a doctor blade (shown), wire, brush, air blast, or other suitable means.

According to yet other embodiments and as shown in FIG. 2, the batch of porous catalytic carrier filaments 219 removed from the belt loop 216 are collected in collecting means 256 and, if necessary, screened to remove dust. The batch of porous catalytic carrier filaments 219 so produced are finished, loose grain materials, which do not require further cutting to length with each filamentary filament having substantially the same aspect ratio, provided that the pressure exerted by the forcing means 214 was substantially constant across its entire face.

According to still other embodiments, and as shown in FIG. 2, after the batch of porous catalytic carrier filaments 219 are removed for final processing, the belt loop 216 continues around its path. While not always required, the belt loop may pass through a cleaning means 258, such as a rotating brush (shown), so as to remove any remaining catalytic carrier material and thereby avoid any clogging problems. Suitable cleaning means include vacuum, stiff wire brushes, water solvent jets, ultrasound, and air blasts.

According to particular embodiments, the forcing means 216 is preferably an extruder such as a horizontal piston extruder, an auger extruder, or other devices such as a pump, doctor blade, or roller. As shown in FIG. 2, the forcing means is positioned immediately adjacent to and in tight register with the belt loop 216. In the case of an extruder such as a horizontal piston extruder, the belt loop is stretched across the exit slot of the extruder so that the material that exits the extruder passes immediately through the perforated belt loop 216.

According to yet other embodiments, the belt loop 216 may be made of any suitable material such as stainless steel or other acid and high temperature resistant material. The perforations in the belt loop may be obtained by using a wire mesh of the desired opening size or by using punched hole, laser cut, chemically etched, or electro-etched sheets. Alternatively, the belt may be a “sacrificial” belt which is used a single time and not repeatedly as in a continuous loop. The perforations in the belt may be of any size or shape depending upon the desired size and shape of the filamentary filaments to be produced. For example, the perforations may be designed to produce generally cylindrical filamentary filaments after firing having a diameter of at least about 0.01 mm and not greater than about 5 mm. According to still other embodiments, the perforations in the belt loop 216 may be configured to produce filamentary filaments of various shapes, including having square, rectangular, triangular, and star shaped cross sections. Generally, the perforations are spaced such that the filaments do not touch each other while adhered to the belt. On the other hand, the spacing should not be so great that the internal pressure of the forcing means is excessive. It is found that suitable belts generally contain from about 20% to about 40% of perforations in the surface area. Usually, about 30% of the belt surface area is represented by the perforations.

According to certain embodiments, the length and thereby the aspect ratio of the batch of porous catalytic carrier filaments 219 may be controlled by controlling the velocity at which the belt loop 216 moves; the greater the velocity the lower the aspect ratio of the batch of porous catalytic carrier filaments 219. Provided (i) the belt loop travels at a steady rate during a forcing run, (ii) each of the perforations is of equivalent size, and (iii) the pressure is constant across the entire face of the forcing means the aspect ratio of the filamentary filaments produced during that run will all be substantially the same.

In addition, the aspect ratio of the batch of porous catalytic carrier filaments 219 is dependent on the delivery rate of the dispersion to the orifice of the forcing means 214. This in turn is controlled by the pressure of the extruder, the pH, and the solids content of the aqueous dispersion being processed. Higher delivery rates will produce greater aspect ratios, as will lower solids content. Generally, pressures of about 2 psi to about 500 psi or more will be used with those compositions having a higher solids content requiring the higher pressures.

Referring now to the precursor mixture (i.e., the precursor mixture described in reference to forming process 100 and/or the precursor mixture 211 described in reference to system 200), according to certain embodiments, the precursor mixture may include any combination of materials necessary for forming a porous catalytic carrier filament. For example, the precursor mixture may include, as primary constituents, materials such as alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof. According to still other embodiments, additional components may include water, organic solvents, acids, bases, organic additives, and metal dopants.

Referring now to the batch of porous catalytic carrier filaments (i.e., the batch of porous catalytic carrier filaments described in reference to forming process 100 and/or the batch of porous catalytic carrier filaments described in reference to system 200), according to certain embodiments, the batch of porous catalytic carrier filaments may include the batch of porous catalytic carrier filaments may include materials such as alumina, silica, titania, zirconia, magnesia, silicon carbide, carbon, zeolites, metal organic frameworks (MOFs), spinels, perovskites, and combinations thereof. According to still other embodiments, metal dopants may be present in a concentration of less than 10 weight percent.

According to still other embodiments, the batch of porous catalytic carrier filaments may have a particular average pore volume. For purposes of embodiments described herein, the average pore volume of a sample of the batch of porous catalytic carrier filaments is measured using a conventional mercury intrusion porosimetry device in which liquid mercury is forced into the pores of a carrier. Greater pressure is needed to force the mercury into the smaller pores and the measurement of pressure increments corresponds to volume increments in the pores penetrated and hence to the size of the pores in the incremental volume. As used herein, average pore volume is measured by mercury intrusion porosimetry (capable pressure range of 0.4-60,000 psi) using a Micromeritics AutoPore IV 9500 Series (1300 contact angle, mercury with a surface tension of 0.480 N/m, and correction for mercury compression applied).

According to particular embodiments, the batch of porous catalytic carrier filaments may have an average pore volume of at least about 0.1 cm³/g, such as, at least about 0.15 cm³/g or at least about 0.2 cm³/g or at least about 0.25 cm³/g or at least about 0.3 cm³/g at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or even at least about 0.8 cm³/g. According to still other embodiments, the batch of porous catalytic carrier filaments may have an average pore volume of not greater than about 10 cm³/g, such as, not greater than about 9 cm³/g or not greater than about 8 cm³/g or not greater than about 7 cm³/g or not greater than about 6 cm³/g or even not greater than about 5 cm³/g. It will be appreciated that the average pore volume of the batch of porous catalytic carrier filaments may be any value between, and including, any of the minimum and maximum values noted above. It will be further appreciated that the average pore volume of the batch of porous catalytic carrier filaments may be within a range between, and including, any of the minimum and maximum values noted above.

According to still other embodiments, the batch of porous catalytic carrier filaments may have a particular average specific surface area. For purposes of embodiments described herein, the average specific surface area of a sample of the batch of porous catalytic carrier filaments is determined by the BET method. A sample is first degassed at 250° C. for 2 hours prior to analysis. The Micromeritics ASAP 2420 is then used to determine the surface area of the sample using a 5-point BET analysis.

According to particular embodiments, the batch of porous catalytic carrier filaments may have an average specific surface area of at least about 0.1 m²/g, such as, at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or even at least about 200 m²/g. According to still other embodiments, the batch of porous catalytic carrier filaments may have an average specific surface area of not greater than about 2000 m²/g, such as, not greater than about 1500 m²/g or not greater than about 1000 m²/g or not greater than about 500 m²/g or not greater than about 400 m²/g or even not greater than about 300 m²/g. It will be appreciated that the average specific surface area of the batch of porous catalytic carrier filaments may be any value between, and including, any of the minimum and maximum values noted above. It will be further appreciated that the average specific surface area of the batch of porous catalytic carrier filaments may be within a range between, and including, any of the minimum and maximum values noted above.

According to still other embodiments, the batch of porous catalytic carrier filaments may have a particular average packing density. For purposes of embodiments described herein, average packing density is measured using a 100 mL graduated cylinder, which is weighed and then filled to the 100 mL level with a sample of the batch of porous catalytic carrier filaments. An AT-2 Autotap Tap Density Analyzer (manufactured by Quantachrome Instruments located in Boynton Beach, FL, USA) is set to perform 1000 taps and tapping is initiated. After completion of 1000 taps, the volume of the sample is measured to the nearest 0.5 mL. The sample and graduated cylinder are then weighed and the mass of the empty graduated cylinder is subtracted to yield the mass of the sample, which is then divided by the volume of the sample to obtain the packing density.

According to particular embodiments, the batch of porous catalytic carrier filaments may have an average packing density of not greater than about 1.9 g/cm³, such as, not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or even not greater than about 1.0 g/cm³. According to still other embodiments, the batch of porous catalytic carrier filaments may have an average packing density of at least about 0.1 g/cm³. It will be appreciated that the average packing density of the batch of porous catalytic carrier filaments may be any value between, and including, any of the minimum and maximum values noted above. It will be further appreciated that the average packing density of the batch of porous catalytic carrier filaments may be within a range between, and including, any of the minimum and maximum values noted above.

According to yet other embodiments, the batch of porous catalytic carrier filaments may have a particular envelope density. For purposes of embodiments described herein, envelope density is measured using a Micromeritics Geo-Pycnometerl360 instrument. This instrument determines envelope density by measuring the change in volume when a sample of known mass is introduced into a chamber containing Micromeritics DryFlo™. DryFlo consists of small beads covered in graphite powder. A calibration is first performed with only DryFlo present in the cylindrical sample chamber. The contents of the chamber are pressed by a plunger to a maximum force of 90 N, and the distance that the plunger is pressed to achieve this force is recorded by the instrument. From this distance measurement, the volume of the DryFlo within the sample chamber is calculated by the instrument. This cycle is repeated five times for the calibration, and the average volume is obtained. The chamber and plunger are then removed and a sample of the batch of porous catalytic carrier filaments of known mass (about 2.5 grams) is added to the DryFlo in the chamber. The measured mass is input into the instrument. The process of pressing the plunger to a maximum force of 90 N is then repeated for five cycles with the sample present in the chamber. The instrument calculates the average volume of the DryFlo-sample mixture from the distance that the plunger was pressed for each cycle. By subtracting the average volume for the DryFlo calibration from the average volume for the DryFlo-sample run, the volume of the sample is obtained. With the mass of the sample known, the instrument outputs the density of the sample by dividing mass by volume.

According to yet other embodiments, the batch of porous catalytic carrier filaments may have an envelope density of at least about 0.1 g/cm³, such as, at least about 0.12 g/cm³ or at least about 0.14 g/cm³ or at least about 0.16 g/cm³ or at least about 0.18 g/cm³ or at least about 0.2 g/cm³ or even at least about 0.22 g/cm³. According to still other embodiments, the batch of porous catalytic carrier filaments may have an envelope density of not greater than about 5.0 g/cm³, such as, not greater than about 4.75 g/cm³ or not greater than about 4.5 g/cm³ or not greater than about 4.25 g/cm³ or not greater than about 4.0 g/cm³ or not greater than about 3.75 g/cm³ or not greater than about 3.5 g/cm³ or not greater than about 3.25 g/cm³ or not greater than about 3.0 g/cm³ or not greater than about 2.75 g/cm³ or not greater than about 2.5 g/cm³ or not greater than about 2.4 g/cm³ or not greater than about 2.3 g/cm³ or not greater than about 2.28 g/cm³ or not greater than about 2.26 g/cm³ or not greater than about 2.24 g/cm³ or even not greater than about 2.22 g/cm³. It will be appreciated that the envelope density of the batch of porous catalytic carrier filaments may be any value between, and including, any of the minimum and maximum values noted above. It will be further appreciated that the envelope density of the batch of porous catalytic carrier filaments may be within a range between, and including, any of the minimum and maximum values noted above.

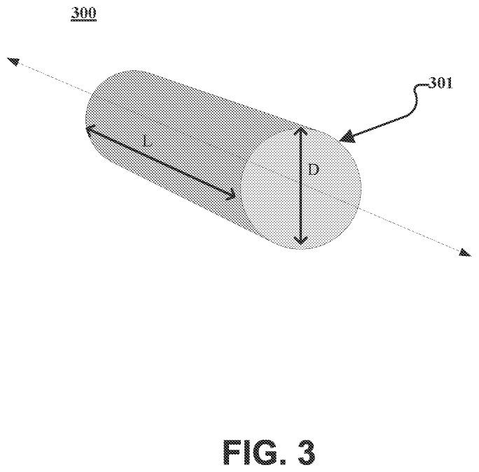

According to yet other embodiments, the batch of porous catalytic carrier filaments may include a plurality of filaments having a columnar shape with a particular cross-sectional shape along the length of the filament. For purposes of illustration, FIG. 3 includes an illustration of a filament 300 formed according to embodiments described herein. As shown in FIG. 3, according to certain embodiments, the filament 300 may have a circular cross-sectional shape 301 along the length of the filament. According to yet other embodiments, the plurality of filaments may have an oval cross-sectional shape along the length of the filament. According to still other embodiments, the plurality of filaments may have a polygonal cross-sectional shape along the length of the filament.

According to still other embodiments, the filaments in the batch of porous catalytic carrier filaments, which has a columnar shape, may have basic dimensions including length (L), cross-sectional diameter (D), and aspect ratio (AR). For purposes of embodiments described herein, FIG. 3 includes an illustration showing the length (L) of a filament, which is defined as the greatest dimension perpendicular to the cross-sectional shape 301 of the filament. FIG. 3 also includes an illustration showing the cross-sectional diameter (D), which is defined as the greatest dimension of the cross-sectional shape of the filament. For purposes of embodiments described herein, the aspect ratio (AR) of filaments in the batch of porous catalytic carrier filaments is equal to the length (L) of a filament in the batch of porous catalytic carrier filaments divided by the cross-sectional diameter (D) of the filament in the batch of porous catalytic carrier filaments.

It will be appreciated that all measurements, including average length (L), average cross-sectional diameter (i.e., equivalent diameter) (D), and average particle aspect ratio (AR), of a particular batch of porous catalytic carrier filaments are measured using images collected with an Olympus DSX510 digital optical microscope. Filaments of a sample batch are placed on the microscope stage and distributed in a monolayer. The height of the lens is adjusted to bring the filament boundaries into focus. The “Live Panorama” tool is used to stitch together a 9 frame by 9 frame image. Measurements of length and diameter are made for at least 20 filaments from the image using the “Measure” tool within the Olympus software. The aspect ratio (AR) of a given filament is calculated by dividing the length by diameter (L/D).

It will be further appreciated that all filament size measurements (i.e., D, L, and AR) may be described herein in combination with D-Values (i.e., D₁₀, D₅₀, and D₉₀), which may be understood to represent the distribution intercepts for 10%, 50% and 90% of the cumulative mass of a particular batch of porous catalytic carrier filaments. For example, a particular batch of filaments may have a Diameter D₁₀ value (i.e., DD₁₀) defined as the diameter at which 10% of the filaments of the sample are comprised of filaments with a diameter less than this value, a particular batch of filaments may have a Diameter D₅₀ value (i.e., DD₅₀) defined as the diameter at which 50% of the filaments of the sample are comprised of filaments with a diameter less than this value, and a particular batch of filaments may have a Diameter D₉₀ value (i.e., DD₉₀) defined as the diameter at which 90% of the filaments of the sample are comprised of filaments with a diameter less than this value. Further, a particular batch of filaments may have a Length D₁₀ value (i.e., LD₁₀) defined as the length at which 10% of the filaments of the sample are comprised of filaments with a length less than this value, a particular batch of filaments may have a Length D₅₀ value (i.e., LD₅₀) defined as the length at which 50% of the filaments of the sample are comprised of filaments with a length less than this value, and a particular batch of filaments may have a Length D₉₀ value (i.e., LD₉₀) defined as the length at which 90% of the filaments of the sample are comprised of filaments with a length less than this value. Finally, a particular batch of filaments may have an Aspect Ratio D₁₀ value (i.e., ARD₁₀) defined as the aspect ratio at which 10% of the filaments of the sample are comprised of filaments with an aspect ratio less than this value, a particular batch of filaments may have an Aspect Ratio D₅₀ value (i.e., ARD₅₀) defined as the aspect ratio at which 50% of the filaments of the sample are comprised of filaments with an aspect ratio less than this value, and a particular batch of filaments may have an Aspect Ratio D₉₀ value (i.e., ARD₉₀) defined as the aspect ratio at which 90% of the filaments of the sample are comprised of filaments with an aspect ratio less than this value.

According to still other embodiments, the batch of porous catalytic carrier filaments may have a particular length (L) distribution span PLDS, where PLDS is equal to (LD₉₀-LD₁₀)/LD₅₀, where LD₉₀ is equal to an LD₉₀ filament length (L) distribution measurement of the batch of porous catalytic carrier filaments, LD₁₀ is equal to an LD₁₀ filament length (L) distribution measurement. According to certain embodiments, the batch of porous catalytic carrier filaments may have a length (L) distribution span PLDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the length (L) distribution span PLDS of the batch of porous catalytic carrier filaments may be any value between, and including, any of the minimum and maximum values noted above. It will be further appreciated that the length (L) distribution span PLDS of the batch of porous catalytic carrier filaments may be within a range between, and including, any of the minimum and maximum values noted above.

According to still other embodiments, the batch of porous catalytic carrier filaments may have a particular diameter (D) distribution span PDDS, where PDDS is equal to (DD₉₀−DD₁₀)/DD₅₀, where DD₉₀ is equal to a DD₉₀ filament diameter (D) distribution measurement of the batch of porous catalytic carrier filaments, DD₁₀ is equal to a DD₁₀ filament diameter (D) distribution measurement. According to certain embodiments, the batch of porous catalytic carrier filaments may have a diameter (D) distribution span PDDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the diameter (D) distribution span PDDS of the batch of porous catalytic carrier filaments may be any value between, and including, any of the minimum and maximum values noted above. It will be further appreciated that the diameter (D) distribution span PDDS of the batch of porous catalytic carrier filaments may be within a range between, and including, any of the minimum and maximum values noted above.

According to still other embodiments, the batch of porous catalytic carrier filaments may have a particular aspect ratio (AR) distribution span PARDS, where PARDS is equal to (ARD₉₀−ARD₁₀)/ARD₅₀, where ARD₉₀ is equal to an ARD₉₀ filament aspect ratio (AR) distribution measurement of the batch of porous catalytic carrier filaments, ARD₁₀ is equal to an ARD₁₀ filament aspect ratio (AR) distribution measurement. According to certain embodiments, the batch of porous catalytic carrier filaments may have an aspect ratio (AR) distribution span PARDS of not greater than about 50%, such as, not greater than about 49% or not greater than about 48% or not greater than about 47% or not greater than about 46% or not greater than about 45% or not greater than about 44% or not greater than about 43% or not greater than about 42% or not greater than about 41% or even not greater than about 40%. It will be appreciated that the aspect ratio (AR) distribution span PARDS of the batch of porous catalytic carrier filaments may be any value between, and including, any of the minimum and maximum values noted above. It will be further appreciated that the aspect ratio (AR) distribution span PARDS of the batch of porous catalytic carrier filaments may be within a range between, and including, any of the minimum and maximum values noted above.

According to yet other embodiments, the batch of porous catalytic carrier filaments may have a particular average filament cross-sectional diameter (D). According to certain embodiments, the batch of porous catalytic carrier filaments may have an average cross-sectional diameter of not greater than about 5 mm, such as, not greater than about 4.5 mm or not greater than about 4.0 mm or not greater than about 3.5 mm or not greater than about 3.0 mm or even not greater than about 2.0 mm. According to still other embodiments, the batch of porous catalytic carrier filaments may have an average cross-sectional diameter of at least about 0.01 mm, such as, at least about 0.05 mm or at least about 0.1 mm or at least about 0.5 mm or at least about 1.0 mm or at least about 1.5 mm or even at least about 2.0 mm. It will be appreciated that the average cross-sectional diameter of the batch of porous catalytic carrier filaments may be any value between, and including, any of the minimum and maximum values noted above. It will be further appreciated that the average cross-sectional diameter of the batch of porous catalytic carrier filaments may be within a range between, and including, any of the minimum and maximum values noted above.

According to still other embodiments, the batch of porous catalytic carrier filaments may have a particular average length (L). According to certain embodiments, the batch of porous catalytic carrier filaments may have an average filament length of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or not greater than about 6.0 mm or not greater than about 5.5 mm or even not greater than about 5.0 mm. According to yet other embodiments, the batch of porous catalytic carrier filaments may have an average filament length of at least about 0.01 mm, such as, at least about 0.05 mm or at least about 0.1 mm or at least about 0.5 mm or at least about 1.0 mm or at least about 1.5 mm or even at least about 2.0 mm. It will be appreciated that the average length of the batch of porous catalytic carrier filaments may be any value between, and including, any of the minimum and maximum values noted above. It will be further appreciated that the average length of the batch of porous catalytic carrier filaments may be within a range between, and including, any of the minimum and maximum values noted above.

According to yet other embodiments, the batch of porous catalytic carrier filaments may have a particular average aspect ratio (AR). According to certain embodiments, the batch of porous catalytic carrier filaments may have an average aspect ratio (AR) of not greater than about 20, such as, not greater than about 19 or not greater than about 18 or not greater than about 17 or not greater than about 16 or not greater than about 15 or not greater than about 14 or not greater than about 13 or not greater than about 12 or not greater than about 11 or even not greater than about 10. According to still other embodiments, the batch of porous catalytic carrier filaments may have an average aspect ratio (AR) of at least about 0.5, such as, at least about 1 or at least about 2 or at least about 3 or at least about 4 or at least about 5 or at least about 6 or even at least about 7. It will be appreciated that the average aspect ratio (AR) of the batch of porous catalytic carrier filaments may be any value between, and including, any of the minimum and maximum values noted above. It will be further appreciated that the average aspect ratio (AR) of the batch of porous catalytic carrier filaments may be within a range between, and including, any of the minimum and maximum values noted above.

According to still other embodiments, the porous catalytic carrier filaments may not be configured for use as abrasive filaments. According to other embodiments, the porous catalytic carrier filaments may not be abrasive filaments.

According to yet other embodiments, the porous catalytic carrier filaments may not be configured for use in material removal through a grinding operation. According to yet other embodiments, the porous catalytic carrier filaments may not be configured for use in material removal through a grinding operation of a workpiece having a particular Vickers hardness. For example, the porous catalytic carrier filaments may not be configured for use in material removal through a grinding operation of a workpiece having a Vickers hardness of at least about 5 GPa, such as, at least about 10 GPa or even at least about 15 GPa. It will be appreciated that the workpiece Vickers hardness may be any value between, and including, any of the minimum and maximum values noted above. It will be further appreciated that the workpiece Vickers hardness may be within a range between, and including, any of the minimum and maximum values noted above.

According to yet other embodiments, the porous catalytic carrier filaments may have a Mohs hardness that is not greater than a Mohs hardness of abrasive filaments. According to certain embodiments, the porous catalytic carrier filaments have a particular Mohs hardness. For example, the Mohs hardness of the porous catalytic carrier filaments may be not greater than about 5, such as, not greater than about 4 or not greater than about 3 or not greater than about 2 or even not greater than about 1. It will be appreciated that the Mohs hardness of the porous catalytic carrier filaments may be any value between, and including, any of the minimum and maximum values noted above. It will be further appreciated that the Mohs hardness of the porous catalytic carrier filaments may be within a range between, and including, any of the minimum and maximum values noted above.

According to yet other embodiments, the porous catalytic carrier filaments may have a Vickers hardness that is not greater than a Vickers hardness of abrasive filaments. According to certain embodiments, the porous catalytic carrier filaments have a particular Vickers hardness. For example, the Vickers hardness of the porous catalytic carrier filaments may be not greater than about 15, such as, not greater than about 10 or even not greater than about 5. It will be appreciated that the Vickers hardness of the porous catalytic carrier filaments may be any value between, and including, any of the minimum and maximum values noted above. It will be further appreciated that the Vickers hardness of the porous catalytic carrier filaments may be within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a batch of porous catalytic carrier filaments, wherein the method comprises: providing a precursor mixture, forcing the precursor mixture at a fixed rate through an orifice and then through a multiplicity of perforations in a belt, wherein the belt moves across and in tight registry with said orifice to form a batch of precursor porous catalytic carrier filaments, drying the batch of precursor porous catalytic carrier filaments to form the batch of greenware porous catalytic carrier filaments, and firing the batch of greenware porous catalytic carrier filaments to form the batch of porous catalytic carrier filaments, wherein the batch of porous catalytic carrier filaments comprises an average pore volume of at least about 0.1 cm³/g.

Embodiment 2. A method of forming a batch of porous catalytic carrier filaments, wherein the method comprises: providing a precursor mixture, forcing the precursor mixture at a fixed rate through an orifice and then through a multiplicity of perforations in a belt, wherein the belt moves across and in tight registry with said orifice to form a batch of precursor porous catalytic carrier filaments, drying the batch of precursor porous catalytic carrier filaments to form the batch of greenware porous catalytic carrier filaments, and firing the batch of greenware porous catalytic carrier filaments to form the batch of porous catalytic carrier filaments, wherein the batch of porous catalytic carrier filaments comprises an average specific surface area of at least about 0.1 m²/g.

Embodiment 3. A method of forming a batch of porous catalytic carrier filaments, wherein the method comprises: providing a precursor mixture, forcing the precursor mixture at a fixed rate through an orifice and then through a multiplicity of perforations in a belt, wherein the belt moves across and in tight registry with said orifice to form a batch of precursor porous catalytic carrier filaments, drying the batch of precursor porous catalytic carrier filaments to form the batch of greenware porous catalytic carrier filaments, and firing the batch of greenware porous catalytic carrier filaments to form the batch of porous catalytic carrier filaments, wherein the batch of porous catalytic carrier filaments comprises an average packing density of not greater than about 1.9 g/cm³.

Embodiment 4. The method of any one of embodiments 1, 2, and 3, wherein the precursor mixture comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

Embodiment 5. The method of any one of embodiments 1, 2, and 3, wherein the batch of porous catalytic carrier filaments comprises alumina, silica, titania, zirconia, magnesia, silicon carbide, carbon, zeolites, metal organic frameworks (MOFs), spinels, perovskites, and combinations thereof.

Embodiment 6. The method of any one of embodiments 1, 2, and 3, wherein the batch of porous catalytic carrier filaments comprise an average pore volume of at least about 0.1 cm³/g or at least about 0.15 cm³/g or at least about 0.2 cm³/g or at least about 0.25 cm³/g or at least about 0.3 cm³/g cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 7. The method of any one of embodiments 1, 2, and 3, wherein the batch of porous catalytic carrier filaments comprise an average pore volume of not greater than about 10 cm³/g or not greater than about 9 cm³/g or not greater than about 8 cm³/g or not greater than about 7 cm³/g or not greater than about 6 cm³/g or not greater than about 5 cm³/g.

Embodiment 8. The method of any one of embodiments 1, 2, and 3, wherein the batch of porous catalytic carrier filaments comprise an average specific surface area of at least about 0.1 m²/g or at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or at least about 200 m²/g.

Embodiment 9. The method of any one of embodiments 1, 2, and 3, wherein the batch of porous catalytic carrier filaments comprise an average specific surface area of not greater than about 2000 m²/g or not greater than about 1500 m²/g or not greater than about 1000 m²/g or not greater than about 500 m²/g or not greater than about 400 m²/g or not greater than about 300 m²/g.

Embodiment 10. The method of any one of embodiments 1, 2, and 3, wherein the batch of porous catalytic carrier filaments comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or not greater than about 1.0 g/cm³.

Embodiment 11. The method of any one of embodiments 1, 2, and 3, wherein the batch of porous catalytic carrier filaments comprise an average packing density of at least about 0.1 g/cm³.

Embodiment 12. The method of any one of embodiments 1, 2, and 3, wherein the batch of porous catalytic carrier filaments comprise an envelope density of at least about 0.1 g/cm³.

Embodiment 13. The method of any one of embodiments 1, 2, and 3, wherein the batch of porous catalytic carrier filaments comprise an envelope density of not greater than about 5.0 g/cm³.

Embodiment 14. The method of any one of embodiments 1, 2, and 3, wherein the batch of porous catalytic carrier filaments comprises a plurality of filaments having a columnar shape.

Embodiment 15. The method of any one of embodiments 1, 2, and 3, wherein the batch of porous catalytic carrier filaments comprises a plurality of filaments having a circular cross-sectional shape.

Embodiment 16. The method of any one of embodiments 1, 2, and 3, wherein the batch of porous catalytic carrier filaments comprises a plurality of filaments having an oval cross-sectional shape.

Embodiment 17. The method of any one of embodiments 1, 2, and 3, wherein the batch of porous catalytic carrier filaments comprises a plurality of filaments having a polygonal cross-sectional shape.

Embodiment 18. The method of any one of embodiments 1, 2, and 3, wherein the batch of porous catalytic carrier filaments has an average filament diameter of not greater than about 0.5 mm and a filament aspect ratio (L/D) distribution span PARDS of not greater than about 50%, where PARDS is equal to (AR₉₀-AR₁₀)/AR₅₀, where AR₉₀ is equal to an AR₉₀ filament aspect ratio (L/D) distribution measurement of the batch of porous catalytic carrier filaments, AR₁₀ is equal to an AR₁₀ filament aspect ratio (L/D) distribution measurement, and AR₅₀ is equal to an AR₅₀ filament aspect ratio (L/D) distribution measurement.

Embodiment 19. The method of any one of embodiments 1, 2, and 3, wherein the batch of porous catalytic carrier filaments has an average filament diameter of not greater than about 5 mm.

Embodiment 20. The method of any one of embodiments 1, 2, and 3, wherein the batch of porous catalytic carrier filaments has an average filament diameter of at least about 0.01 mm.

Embodiment 21. The method of any one of embodiments 1, 2, and 3, wherein the batch of porous catalytic carrier filaments has an average filament length of at least about 0.01 mm.

Embodiment 22. The method of any one of embodiments 1, 2, and 3, wherein the batch of porous catalytic carrier filaments has an average filament length of not greater than about 10 mm.

Embodiment 23. The method of any one of embodiments 1, 2, and 3, wherein the batch of porous catalytic carrier filaments has an average aspect ratio (L/D) of not greater than about 20.

Embodiment 24. The method of any one of embodiments 1, 2, and 3, wherein the batch of porous catalytic carrier filaments has an average aspect ratio (L/D) of at least about 0.5.

Embodiment 25. The method of any one of embodiments 1, 2, and 3, wherein the porous catalytic carrier filaments are not configured for use as abrasive filaments.

Embodiment 26. The method of any one of embodiments 1, 2, and 3, wherein the porous catalytic carrier filaments are not abrasive filaments.

Embodiment 27. The method of any one of embodiments 1, 2, and 3, wherein the porous catalytic carrier filaments can not be configured for use in material removal through a grinding operation.

Embodiment 28. The method of any one of embodiments 1, 2, and 3, wherein the porous catalytic carrier filaments can not be configured for use in material removal through a grinding operation of a workpiece having a Vickers hardness of at least about 5 GPa, at least about 10 GPa, at least about 11 GPa.

Embodiment 29. The method of any one of embodiments 1, 2, and 3, wherein the porous catalytic carrier filaments have a hardness not greater than a hardness of abrasive filaments.

Embodiment 30. The method of any one of embodiments 1, 2, and 3, wherein the porous catalytic carrier filaments have a Mohs hardness that is not greater than a Mohs hardness of abrasive filaments.

Embodiment 31. The method of any one of embodiments 1, 2, and 3, wherein the porous catalytic carrier filaments have a Mohs hardness of not greater than about 7, not greater than about 6, not greater than about 5, not greater than about 4, not greater than about 3, not greater than about 2, not greater than about 1.

Embodiment 32. The method of any one of embodiments 1, 2, and 3, wherein the porous catalytic carrier filaments have a Vickers hardness that is not greater than a Vickers hardness of abrasive filaments.

Embodiment 33. The method of any one of embodiments 1, 2, and 3, wherein the porous catalytic carrier filaments have a Vickers hardness of not greater than about 11 GPa, not greater than about 10 GPa, not greater than about 5 GPa.

Embodiment 34. A batch of porous catalytic carrier filaments comprising an average aspect ratio (L/D) of at least about 0.5 and wherein the batch of porous catalytic carrier filaments comprises an average pore volume of at least about 0.1 cm³/g.

Embodiment 35. A batch of porous catalytic carrier filaments comprising an average aspect ratio (L/D) of at least about 0.5 and wherein the batch of porous catalytic carrier filaments comprises an average specific surface area of at least about 0.1 m²/g.

Embodiment 36. A batch of porous catalytic carrier filaments comprising an average aspect ratio (L/D) of at least about 0.5 and wherein the batch of porous catalytic carrier filaments comprises an average packing density of not greater than about 1.9 g/cm³.

Embodiment 37. The batch of porous catalytic carrier filaments of any one of embodiments 34, 35, and 36, wherein the batch of porous catalytic carrier filaments comprises alumina, silica, titania, zirconia, magnesia, silicon carbide, carbon, zeolites, metal organic frameworks (MOFs), spinels, perovskites, and combinations thereof.

Embodiment 38. The batch of porous catalytic carrier filaments of any one of embodiments 34, 35, and 36, wherein the batch of porous catalytic carrier filaments comprise an average pore volume of at least about 0.1 cm³/g or at least about 0.15 cm³/g or at least about 0.2 cm³/g or at least about 0.25 cm³/g or at least about 0.3 cm³/g cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 39. The batch of porous catalytic carrier filaments of any one of embodiments 34, 35, and 36, wherein the batch of porous catalytic carrier filaments comprise an average pore volume of not greater than about 10 cm³/g or not greater than about 9 cm³/g or not greater than about 8 cm³/g or not greater than about 7 cm³/g or not greater than about 6 cm³/g or not greater than about 5 cm³/g.

Embodiment 40. The batch of porous catalytic carrier filaments of any one of embodiments 34, 35, and 36, wherein the batch of porous catalytic carrier filaments comprise an average specific surface area of at least about 0.1 m²/g or at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or at least about 200 m²/g.

Embodiment 41. The batch of porous catalytic carrier filaments of any one of embodiments 34, 35, and 36, wherein the batch of porous catalytic carrier filaments comprise an average specific surface area of not greater than about 2000 m²/g or not greater than about 1500 m²/g or not greater than about 1000 m²/g or not greater than about 500 m²/g or not greater than about 400 m²/g or not greater than about 300 m²/g.

Embodiment 42. The batch of porous catalytic carrier filaments of any one of embodiments 34, 35, and 36, wherein the batch of porous catalytic carrier filaments comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or not greater than about 1.0 g/cm³.

Embodiment 43. The batch of porous catalytic carrier filaments of any one of embodiments 34, 35, and 36, wherein the batch of porous catalytic carrier filaments comprise an average packing density of at least about 0.1 g/cm³.

Embodiment 44. The batch of porous catalytic carrier filaments of any one of embodiments 34, 35, and 36, wherein the batch of porous catalytic carrier filaments comprise an envelope density of at least about 0.1 g/cm³.

Embodiment 45. The batch of porous catalytic carrier filaments of any one of embodiments 34, 35, and 36, wherein the batch of porous catalytic carrier filaments comprise an envelope density of not greater than about 5.0 g/cm³.

Embodiment 46. The batch of porous catalytic carrier filaments of any one of embodiments 34, 35, and 36, wherein the batch of porous catalytic carrier filaments comprises a plurality of filaments having a columnar shape.

Embodiment 47. The batch of porous catalytic carrier filaments of any one of embodiments 34, 35, and 36, wherein the batch of porous catalytic carrier filaments comprises a plurality of filaments having a circular cross-sectional shape.

Embodiment 48. The batch of porous catalytic carrier filaments of any one of embodiments 34, 35, and 36, wherein the batch of porous catalytic carrier filaments comprises a plurality of filaments having an oval cross-sectional shape.

Embodiment 49. The batch of porous catalytic carrier filaments of any one of embodiments 34, 35, and 36, wherein the batch of porous catalytic carrier filaments comprises a plurality of filaments having a polygonal cross-sectional shape.

Embodiment 50. The batch of porous catalytic carrier filaments of any one of embodiments 34, 35, and 36, wherein the batch of porous catalytic carrier filaments has an average filament diameter of not greater than about 5 mm and a filament aspect ratio (L/D) distribution span PARDS of not greater than about 50%, where PARDS is equal to (AR₉₀-AR₁₀)/AR₅₀, where AR₉₀ is equal to an AR₉₀ filament aspect ratio (L/D) distribution measurement of the batch of porous catalytic carrier filaments, AR₁₀ is equal to an AR₁₀ filament aspect ratio (L/D) distribution measurement, and AR₅₀ is equal to an AR₅₀ filament aspect ratio (L/D) distribution measurement.

Embodiment 51. The batch of porous catalytic carrier filaments of any one of embodiments 34, 35, and 36, wherein the batch of porous catalytic carrier filaments has an average filament diameter of not greater than about 5 mm.

Embodiment 52. The batch of porous catalytic carrier filaments of any one of embodiments 34, 35, and 36, wherein the batch of porous catalytic carrier filaments has an average filament diameter of at least about 0.01 mm.

Embodiment 53. The batch of porous catalytic carrier filaments of any one of embodiments 34, 35, and 36, wherein the batch of porous catalytic carrier filaments has an average filament length of at least about 0.01 mm.

Embodiment 54. The batch of porous catalytic carrier filaments of any one of embodiments 34, 35, and 36, wherein the batch of porous catalytic carrier filaments has an average filament length of not greater than about 10 mm.

Embodiment 55. The batch of porous catalytic carrier filaments of any one of embodiments 34, 35, and 36, wherein the batch of porous catalytic carrier filaments has an average aspect ratio (L/D) of not greater than about 20.

Embodiment 56. The batch of porous catalytic carrier filaments of any one of embodiments 34, 35, and 36, wherein the batch of porous catalytic carrier filaments has an average aspect ratio (L/D) of at least about 0.5.

Embodiment 57. The batch of porous catalytic carrier filaments of any one of embodiments 34, 35, and 36, wherein the porous catalytic carrier filaments are not configured for use as abrasive filaments.

Embodiment 58. The batch of porous catalytic carrier filaments of any one of embodiments 34, 35, and 36, wherein the porous catalytic carrier filaments are not abrasive filaments.

Embodiment 59. The batch of porous catalytic carrier filaments of any one of embodiments 34, 35, and 36, wherein the porous catalytic carrier filaments can not be configured for use in material removal through a grinding operation.

Embodiment 60. The batch of porous catalytic carrier filaments of any one of embodiments 34, 35, and 36, wherein the porous catalytic carrier filaments can not be configured for use in material removal through a grinding operation of a workpiece having a Vickers hardness of at least about 5 GPa, at least about 10 GPa, at least about 11 GPa.

Embodiment 61. The batch of porous catalytic carrier filaments of any one of embodiments 34, 35, and 36, wherein the porous catalytic carrier filaments have a hardness not greater than a hardness of abrasive filaments.

Embodiment 62. The batch of porous catalytic carrier filaments of any one of embodiments 34, 35, and 36, wherein the porous catalytic carrier filaments have a Mohs hardness that is not greater than a Mohs hardness of abrasive filaments.

Embodiment 63. The batch of porous catalytic carrier filaments of any one of embodiments 34, 35, and 36, wherein the porous catalytic carrier filaments have a Mohs hardness of not greater than about 7, not greater than about 6, not greater than about 5, not greater than about 4, not greater than about 3, not greater than about 2, not greater than about 1.

Embodiment 64. The batch of porous catalytic carrier filaments of any one of embodiments 34, 35, and 36, wherein the porous catalytic carrier filaments have a Vickers hardness that not greater than a Vickers hardness of abrasive filaments.

Embodiment 65. The batch of porous catalytic carrier filaments of any one of embodiments 34, 35, and 36, wherein the porous catalytic carrier filaments have a Vickers hardness of not greater than about 11 GPa, not greater than about 10 GPa, not greater than about 5 GPa.

Embodiment 66. A system for forming a batch of porous catalytic carrier filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous catalytic carrier filaments, a drying zone comprising a first heat source and being configured to dry the batch of precursor porous catalytic carrier filaments to form the batch of porous greenware catalytic carrier filaments, and a firing (i.e., calcining) zone comprising a second heat source and being configured to form the batch of greenware porous catalytic carrier filaments into the batch of porous catalytic carrier filaments, wherein the batch of porous catalytic carrier filaments comprises an average pore volume of at least about 0.1 cm³/g.

Embodiment 67. A system for forming a batch of porous catalytic carrier filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous catalytic carrier filaments, a drying zone comprising a first heat source and being configured to dry the batch of precursor porous catalytic carrier filaments to form the batch of porous catalytic carrier filaments, and a firing (i.e., calcining) zone comprising a second heat source and being configured to form the batch of greenware porous catalytic carrier filaments into the batch of porous catalytic carrier filaments, wherein the batch of porous catalytic carrier filaments comprises an average specific surface area of at least about 0.1 m²/g.

Embodiment 68. A system for forming a batch of porous catalytic carrier filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous catalytic carrier filaments, a drying zone comprising a first heat source and being configured to dry the batch of precursor porous catalytic carrier filaments to form the batch of porous catalytic carrier filaments, and a firing (i.e., calcining) zone comprising a second heat source and being configured to form the batch of greenware porous catalytic carrier filaments into the batch of porous catalytic carrier filaments, wherein the batch of porous catalytic carrier filaments comprises an average packing density of not greater than about 1.9 g/cm³.

Embodiment 69. The system of any one of embodiments 66, 67, and 68, wherein the batch of porous catalytic carrier filaments comprises alumina, silica, titania, zirconia, magnesia, silicon carbide, carbon, zeolites, metal organic frameworks (MOFs), spinels, perovskites, and combinations thereof.

Embodiment 70. The system of any one of embodiments 66, 67, and 68, wherein the batch of porous catalytic carrier filaments comprise an average pore volume of at least about 0.1 cm³/g or at least about 0.15 cm³/g or at least about 0.2 cm³/g or at least about 0.25 cm³/g or at least about 0.3 cm³/g cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 71. The system of any one of embodiments 66, 67, and 68, wherein the batch of porous catalytic carrier filaments comprise an average pore volume of not greater than about 10 cm³/g or not greater than about 9 cm³/g or not greater than about 8 cm³/g or not greater than about 7 cm³/g or not greater than about 6 cm³/g or not greater than about 5 cm³/g.

Embodiment 72. The system of any one of embodiments 66, 67, and 68, wherein the batch of porous catalytic carrier filaments comprise an average specific surface area of at least about 0.1 m²/g or at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or at least about 200 m²/g.

Embodiment 73. The system of any one of embodiments 66, 67, and 68, wherein the batch of porous catalytic carrier filaments comprise an average specific surface area of not greater than about 2000 m²/g or not greater than about 1500 m²/g or not greater than about 1000 m²/g or not greater than about 500 m²/g or not greater than about 400 m²/g or not greater than about 300 m²/g.

Embodiment 74. The system of any one of embodiments 66, 67, and 68, wherein the batch of porous catalytic carrier filaments comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or not greater than about 1.0 g/cm³.

Embodiment 75. The system of any one of embodiments 66, 67, and 68, wherein the batch of porous catalytic carrier filaments comprise an average packing density of at least about 0.1 g/cm³.

Embodiment 76. The system of any one of embodiments 66, 67, and 68, wherein the batch of porous catalytic carrier filaments comprise an envelope density of at least about 0.1 g/cm³.

Embodiment 77. The system of any one of embodiments 66, 67, and 68, wherein the batch of porous catalytic carrier filaments comprise an envelope density of not greater than about 5.0 g/cm³.

Embodiment 78. The system of any one of embodiments 66, 67, and 68, wherein the batch of porous catalytic carrier filaments comprises a plurality of filaments having a columnar shape.

Embodiment 79. The system of any one of embodiments 66, 67, and 68, wherein the batch of porous catalytic carrier filaments comprises a plurality of filaments having a circular cross-sectional shape.

Embodiment 80. The system of any one of embodiments 66, 67, and 68, wherein the batch of porous catalytic carrier filaments comprises a plurality of filaments having an oval cross-sectional shape.

Embodiment 81. The system of any one of embodiments 66, 67, and 68, wherein the batch of porous catalytic carrier filaments comprises a plurality of filaments having a polygonal cross-sectional shape.

Embodiment 82. The system of any one of embodiments 66, 67, and 68, wherein the batch of porous catalytic carrier filaments has an average filament diameter of not greater than about 5 mm and a filament aspect ratio (L/D) distribution span PARDS of not greater than about 50%, where PARDS is equal to (AR₉₀-AR₁₀)/AR₅₀, where AR₉₀ is equal to an AR₉₀ filament aspect ratio (L/D) distribution measurement of the batch of porous catalytic carrier filaments, AR₁₀ is equal to an AR₁₀ filament aspect ratio (L/D) distribution measurement, and AR₅₀ is equal to an AR₅₀ filament aspect ratio (L/D) distribution measurement.

Embodiment 83. The system of any one of embodiments 66, 67, and 68, wherein the batch of porous catalytic carrier filaments has an average filament diameter of not greater than about 5 mm.

Embodiment 84. The system of any one of embodiments 66, 67, and 68, wherein the batch of porous catalytic carrier filaments has an average filament diameter of at least about 0.01 mm.

Embodiment 85. The system of any one of embodiments 66, 67, and 68, wherein the batch of porous catalytic carrier filaments has an average filament length of at least about 0.01 mm.

Embodiment 86. The system of any one of embodiments 66, 67, and 68, wherein the batch of porous catalytic carrier filaments has an average filament length of not greater than about 10 mm.

Embodiment 87. The system of any one of embodiments 66, 67, and 68, wherein the batch of porous catalytic carrier filaments has an average aspect ratio (L/D) of not greater than about 20.

Embodiment 88. The system of any one of embodiments 66, 67, and 68, wherein the batch of porous catalytic carrier filaments has an average aspect ratio (L/D) of at least about 0.5.

Embodiment 89. The system of any one of embodiments 66, 67, and 68, wherein the porous catalytic carrier filaments are not configured for use as abrasive filaments.

Embodiment 90. The system of any one of embodiments 66, 67, and 68, wherein the porous catalytic carrier filaments are not abrasive filaments.

Embodiment 91. The system of any one of embodiments 66, 67, and 68, wherein the porous catalytic carrier filaments can not be configured for use in material removal through a grinding operation.

Embodiment 92. The system of any one of embodiments 66, 67, and 68, wherein the porous catalytic carrier filaments can not be configured for use in material removal through a grinding operation of a workpiece having a Vickers hardness of at least about 5 GPa, at least about 10 GPa, at least about 11 GPa.

Embodiment 93. The system of any one of embodiments 66, 67, and 68, wherein the porous catalytic carrier filaments have a hardness not greater than a hardness of abrasive filaments.

Embodiment 94. The system of any one of embodiments 66, 67, and 68, wherein the porous catalytic carrier filaments have a Mohs hardness that is not greater than a Mohs hardness of abrasive filaments.

Embodiment 95. The system of any one of embodiments 66, 67, and 68, wherein the porous catalytic carrier filaments have a Mohs hardness of not greater than about 7, not greater than about 6, not greater than about 5, not greater than about 4, not greater than about 3, not greater than about 2, not greater than about 1.

Embodiment 96. The system of any one of embodiments 66, 67, and 68, wherein the porous catalytic carrier filaments have a Vickers hardness that is not greater than a Vickers hardness of abrasive filaments.

Embodiment 97. The system of any one of embodiments 66, 67, and 68, wherein the porous catalytic carrier filaments have a Vickers hardness of not greater than about 11 GPa, not greater than about 10 GPa, not greater than about 5 GPa.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity cannot be required, and that one or more further activities can be performed in addition to those described. Still, further, the order in which activities are listed is not necessarily the order in which they are performed.

The disclosure is submitted with the understanding that it will not be used to limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter can be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a batch of porous catalytic carrier filaments, wherein the method comprises:
providing a precursor mixture,
forcing the precursor mixture at a fixed rate through an orifice and then through a multiplicity of perforations in a belt, wherein the belt moves across and in tight registry with said orifice to form a batch of precursor porous catalytic carrier filaments,
drying the batch of precursor porous catalytic carrier filaments to form the batch of greenware porous catalytic carrier filaments, and
firing the batch of greenware porous catalytic carrier filaments to form the batch of porous catalytic carrier filaments,
wherein the batch of porous catalytic carrier filaments comprises an average pore volume of at least about 0.1 cm³/g.

2. The method of claim 1, wherein the precursor mixture comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

3. The method of claim 1, wherein the batch of porous catalytic carrier filaments comprises alumina, silica, titania, zirconia, magnesia, silicon carbide, carbon, zeolites, metal organic frameworks (MOFs), spinels, perovskites, and combinations thereof.

4. The method of claim 1, wherein the batch of porous catalytic carrier filaments comprise an average specific surface area of at least about 0.1 m²/g.

5. The method of claim 1, wherein the batch of porous catalytic carrier filaments comprise an average packing density of not greater than about 1.9 g/cm³.

6. The method of claim 1, wherein the batch of porous catalytic carrier filaments comprise an envelope density of at least about 0.1 g/cm³.

7. The method of claim 1, wherein the batch of porous catalytic carrier filaments comprises a plurality of filaments having a columnar shape.

8. The method of claim 1, wherein the batch of porous catalytic carrier filaments has an average filament diameter of not greater than about 5 mm and a filament aspect ratio (L/D) distribution span PARDS of not greater than about 50%, where PARDS is equal to (AR₉₀−AR₁₀)/AR₅₀, where AR₉₀ is equal to an AR₉₀ filament aspect ratio (L/D) distribution measurement of the batch of porous catalytic carrier filaments, AR₁₀ is equal to an AR₁₀ filament aspect ratio (L/D) distribution measurement, and AR₅₀ is equal to an AR₅₀ filament aspect ratio (L/D) distribution measurement.

9. The method of claim 1, wherein the batch of porous catalytic carrier filaments has an average filament diameter of not greater than about 5 mm.

10. The method of claim 1, wherein the batch of porous catalytic carrier filaments has an average filament length of at least about 0.01 mm.

11. The method of claim 1, wherein the porous catalytic carrier filaments have a Mohs hardness that is not greater than a Mohs hardness of abrasive filaments.

12. A batch of porous catalytic carrier filaments comprising an average aspect ratio (L/D) of at least about 0.5 and wherein the batch of porous catalytic carrier filaments comprises an average pore volume of at least about 0.1 cm³/g.

13. The batch of porous catalytic carrier filaments of claim 12, wherein the batch of porous catalytic carrier filaments comprises a plurality of filaments having a columnar shape.

14. The batch of porous catalytic carrier filaments of claim 12, wherein the batch of porous catalytic carrier filaments has an average filament diameter of not greater than about 5 mm and a filament aspect ratio (L/D) distribution span PARDS of not greater than about 50%, where PARDS is equal to (AR₉₀−AR₁₀)/AR₅₀, where AR₉₀ is equal to an AR₉₀ filament aspect ratio (L/D) distribution measurement of the batch of porous catalytic carrier filaments, AR₁₀ is equal to an AR₁₀ filament aspect ratio (L/D) distribution measurement, and AR₅₀ is equal to an AR₅₀ filament aspect ratio (L/D) distribution measurement.

15. A system for forming a batch of porous catalytic carrier filaments, wherein the system comprises: an application zone comprising a shaping assembly including a reservoir configured to force a precursor mixture at a fixed rate through an orifice and then through a multiplicity of perforations in a belt, wherein the belt moves across and in tight registry with said orifice to form a batch of precursor porous catalytic carrier filaments, a drying zone comprising a first heat source and being configured to dry the batch of precursor porous catalytic carrier filaments to form the batch of porous catalytic carrier filaments, and a firing (i.e., calcining) zone comprising a second heat source and being configured to form the batch of greenware porous catalytic carrier filaments into the batch of porous catalytic carrier filaments, wherein the batch of porous catalytic carrier filaments comprises an average pore volume of at least about 0.1 cm³/g.
